(19) United States
(12) Patent Application Publication
(10) Pub. No.: US 2022/0364318 A1
(43) Pub. Date: Nov. 17, 2022

(54) QUICK-CHANGE HOLDER, QUICK-CHANGE CHISEL HOLDER SYSTEM, MILLING ROLLER FOR A ROAD MILLING MACHINE, AND ROAD MILLING MACHINE

(71) Applicant: BOMAG GMBH, Boppard (DE)

(72) Inventor: Steffen WACHSMANN, Boppard (DE)

(21) Appl. No.: 17/661,099

(22) Filed: Apr. 28, 2022

(30) Foreign Application Priority Data
May 17, 2021 (DE) 10 2021 112 757.2

(51) Int. Cl. E01C 23/088; B28D 1/18

(52) U.S. Cl. CPC E01C 23/088; B28D 1/188

(57) ABSTRACT

The invention relates to a quick-change holder for a quick-change chisel holder system for fastening a rotationally symmetrical milling chisel to a milling roller of a road milling machine, comprising a quick-change holder body, a chisel shank receptacle running along a longitudinal center axis in the quick-change holder body for receiving a chisel shank of the milling tool, a quick-change holder cone, which is formed by the quick-change holder body, lies in extension of the chisel shank receptacle, and for this purpose is designed to be clamped in an at least partially complementary holder receptacle of a basic holder of the quick-change chisel holder system, a tension means bearing arranged on the quick-change holder cone and designed to engage a tension means, with which the quick-change holder cone can be clamped on the basic holder in the direction of a cone axis of the quick-change holder cone, wherein the chisel shank receptacle and the tension means bearing are designed in such a way that the longitudinal center axis and the cone axis lie in a common plane and are angled relative to one another in this common plane. Furthermore, the invention relates to a quick-change chisel holder system and a milling roller.

### FIELD

The invention relates to a quick-change holder for a quick-change chisel holder system for fastening a rotationally symmetrical milling chisel to a milling roller of a road milling machine. Furthermore, the invention relates to a quick-change chisel holder system for fastening a milling chisel to a milling roller of a road milling machine, to a milling roller for a road milling machine, and to a road milling machine.

### BACKGROUND

Generic road milling machines, in particular self-propelled road milling machines, road millers or cold millers, are typically used to mill off asphalt or concrete surfaces, roadways, runways or landing strips, for example for the purpose of repair or renewal. Such road milling machines are described, for example, in DE102012022879A1, DE102013002639A1 and DE102014011878A1. They are often used in road construction as well as in open public spaces and, for example, airports to remove existing surface coverings to a desired milling depth. As a working unit, such road milling machines usually comprise a milling roller. In particular, this can be a unit having a hollow-cylindrical casing tube, on the outer lateral surface of which there is arranged a large number of milling tools, which for example include milling chisels. During operation, the milling roller is rotated about a rotation axis and lowered into the ground at the desired milling depth, so that the milling chisels are driven into the ground that is to be milled off, thereby milling it open. Depending on the type of work to be carried out, very different milling depths may be necessary. Typical work includes simply roughening the surface of the ground or removing a few millimeters or centimeters, up to and including the complete removal of a base layer up to or including part of the underlying soil. A holder system used for this purpose for fastening the individual milling chisels to the support tube is disclosed, for example, in EP 2 425 951 A1.

The basic structure of the milling chisels usually comprises a chisel shank, which is used for mounting purposes, for example, and a chisel head which adjoins the chisel shank and which can be designed, for example, to be substantially conical, tapering towards a chisel tip. The milling chisels are naturally subject to a high degree of wear, which is why they have to be replaced regularly. It is therefore known in the prior art to use so-called quick-change chisel holder systems, by means of which the milling chisels are fastened to the milling roller and which allow the milling chisels to be replaced as quickly as possible. Such quick-change chisel holder systems typically comprise a basic holder that is attached directly to the outer lateral surface of the milling roller, for example by welding. In these systems, a quick-change holder is detachably fastened to the main holder and in turn serves to detachably receive and fix a milling chisel. Both the milling chisel and the quick-change holder are wearing parts that can and must be changed regularly, wherein the milling chisel is changed more frequently than the quick-change holder. Due to the detachable fastening of the milling chisel to the quick-change holder and the quick-change holder to the basic holder, these components of the milling tool can be replaced or renewed comparatively quickly. Only when the basic holder is also heavily worn does it have to be removed from the milling roller and replaced with a new basic holder, which means more work.

The milling chisels used can be mounted rotatably in the quick-change holder. Such milling chisels are also referred to as rotary milling chisels. For this purpose, it may be provided that they are rotationally symmetrical, in particular substantially cylindrical, at least substantially or at least in the shank region. They are then also referred to as round-shank chisels. They comprise a chisel head with a chisel tip typically comprising hard metal and a chisel shank extending on the side of the chisel head opposite the chisel tip. Such milling chisels are distinguished in that they are typically mounted in the tool changer in such a way that they can rotate freely about their rotation axis during operation of the milling roller. In this way, the milling tip and the chisel head of the milling chisels are evenly worn, which contributes to an increased service life of the milling chisel. To fasten the milling chisel in the quick-change holder, it is typically clamped in a chisel shank receptacle of the quick-change holder using a clamping sleeve, wherein the clamping sleeve prevents an axial displacement of the milling chisel and thus prevents the milling chisel from falling out of the chisel shank receptacle.

In the prior art, various quick-change chisel holder systems for fastening the milling chisel to the milling roller of the road milling machine are known. One such quick-change chisel holder system, known for example from EP 2 425 951 A1, comprises a quick-change holder for fastening a rotationally symmetrical milling chisel to a milling roller of a road milling machine, wherein the quick-change holder comprises a quick-change holder body. In the quick-change holder body, there is arranged a chisel shank receptacle, running along a longitudinal center axis, for receiving a chisel shank of the milling chisel. The longitudinal center axis of the “chisel shank receptacle” cavity is at the same time the central insertion axis along which the milling chisel is inserted into the chisel shank receptacle. In addition, the longitudinal center axis is at the same time the rotation axis of the rotationally symmetrical milling chisel, which is designed, for example, as a round-shank tool. The quick-change holder body likewise comprises or forms a quick-change holder cone lying in extension of the chisel shank receptacle. This quick-change holder cone is designed to be clamped in an at least partially complementary holder receptacle of a basic holder of the quick-change chisel holder system, the at least partially complementary holder receptacle likewise being formed as a cavity. The quick-change holder cone is distinguished in particular by an at least partially cone-shaped or frustoconical lateral surface. It tapers in particular in the direction of the side of the quick-change holder body remote from the chisel shank receptacle or in the direction away from the chisel tip. In this specific type of quick-change chisel holder system, the presence of this quick-change holder cone is of particular importance. In particular, the quick-change holder cone is used to transmit to the quick-change holder both forces caused by the fastening of the quick-change holder to the basic holder and forces that act on the quick-change holder during operation of the milling roller, for example coming from the milling chisel. In particular, the conical or frustoconical lateral surface of the quick-change holder cone is used to transmit the force. In this respect, this type of quick-change chisel holder system differs significantly from other systems that do not have a quick-change holder cone and in which the transmission of force is therefore designed differently. For fastening to the basic holder, the quick-change holder typically has a tension means bearing arranged on the quick-change holder cone. This bearing can be an internal thread, for example. A screw, for example, which can be screwed into the internal thread of the tension means bearing, is therefore a typical tension means. The tension means bearing is designed to engage the tension means, wherein the quick-change holder cone can be clamped with the tension means on the basic holder in the direction of a cone axis of the quick-change holder cone. The cone axis of the quick-change holder cone is the longitudinal center axis of the quick-change holder cone. This is therefore the axis of rotational symmetry of the conical or frustoconical lateral surface of the quick-change holder cone. The quick-change holder or the tension means bearing of the quick-change holder are therefore designed in such a way that the tensile forces applied to the quick-change holder by the tension means act in the direction of the cone axis. In particular, it is provided that the tensile forces of the tension means pull the quick-change holder cone into a holder receptacle of the basic holder in such a way that the lateral surface of the quick-change holder cone lies as flat as possible against the inner surface of the holder receptacle.

This flat contact of the quick-change holder cone in the holder receptacle of the basic holder ensures an effective transmission of force to the basic holder both by the fastening of the quick-change holder to the basic holder and during operation of the milling roller. This transmission of force to the basic holder via the quick-change holder cone and in particular the lateral surface of the latter is an essential feature of the specific form of quick-change chisel holder system described. It is further enhanced by the fact that the longitudinal center axis of the chisel shank receptacle and the cone axis run parallel to each other. Typically, the longitudinal center axis and the cone axis are identical to each other, so that both describe the same axis in space, whereby a reliable force transmission is achieved overall. Such a quick-change chisel holder system has been successfully used by the applicant for years and is described in detail, for example, in EP 2 425 951 A1. For comparison, WO 2012/072 785 A2 shows a different type of quick-change chisel holder system, which does not have a quick-change holder cone. Due to the different design, forces are transmitted completely differently between the quick-change holder and the basic holder in this system, which is why it is also not a generic quick-change chisel holder system of the kind described here.

The milling chisel is fastened to the milling chisel via the quick-change chisel holder system. The particular system therefore also determines the setting angle of the milling chisel, for example in relation to the ground to be milled. In particular, the angle at which the milling chisel or the chisel tip comes into contact with the ground to be milled also depends to a large extent on the milling depth. The milling depth can vary depending on the application. By varying the milling depth accordingly, the quick-change chisel holder system and the milling chisel are repeatedly subjected to different loads, so that they often wear more or less evenly overall. However, the “variation in milling depth” required for this purpose often cannot be achieved in practical use. For example, it may be that thin layers of, for example, a maximum milling depth of 4 cm are to be removed predominantly or even exclusively. Such work or machines intended for such work are referred to as thin-layer milling or thin-layer millers. If a road milling machine or milling roller is used predominantly or exclusively for thin-layer milling, the milling chisels and the quick-change chisel holder system are subjected to a one-sided load so that they do not wear evenly around the longitudinal center axis of the milling chisel. The contact surface, via which the milling chisel rests on the quick-change holder, for example indirectly via a wear plate, is subjected to such one-sided stress that it wears at an angle. The chisel shank receptacle in the quick-change holder is also subjected to such uneven stress that it can deform in an oval shape. Lastly, the uneven loading leads to premature breakage of the milling chisels and to significantly reduced service life compared to tools that are uniformly loaded by alternating milling depths. For this reason, the quick-change holders sometimes have to be replaced already after approximately 150 operating hours instead of the usual approximately 800 operating hours, which is associated with increased costs.

In order to compensate for this increased, uneven wear, various possibilities are known in the prior art. For example, DE 10 2016 224 606 A1 indicates a possibility to machine the unevenly worn parts with a machining tool to compensate for the asymmetrical wear. This requires considerable reworking. WO 00/52 303 A1, in turn, discloses a different type of quick-change chisel holder system which does not have quick-change holder cone. In the system described there, the working angle of the milling chisel relative to the ground surface can be variably adjusted since the quick-change holder is fastenable in different positions relative to the basic holder. However, a corresponding system cannot be used in a quick-change chisel holder system with a quick-change holder cone due to the special force transmission. In addition, the variable system has a complex design and comprises an adjustment mechanism that is prone to wear. Lastly, when using this system, an increased effort must be made during assembly to ensure that all milling chisels are really fixed in the same angular position, as otherwise there will be significantly increased wear at individual tools.

### SUMMARY

Against this background, it is the object of the present invention to avoid the uneven wear of the milling tools, which occurs due to the predominant or exclusive milling of thin layers, in a generic quick-change chisel holder system with a quick-change holder cone. The improved system should be both simple to manufacture and easy to install on the milling roller.

The solution succeeds with a tool changer, a quick-change chisel holder and a milling roller according to the independent claims. Preferred further developments are described in the dependent claims.

Specifically, the solution is successful in the case of a quick-change holder for a quick-change chisel holder system of the type described at the outset, comprising, in detail, a quick-change holder for a quick-change chisel holder system for fastening a milling chisel, in particular a rotationally symmetrical milling chisel, to a milling roller of a road milling machine, wherein the quick-change holder has a quick-change holder body, a chisel shank receptacle, which runs along a longitudinal center axis in the quick-change holder body, for receiving a chisel shank of the milling chisel, a quick-change holder cone formed by the quick-change holder body and lying at least partially in extension of the chisel shank receptacle, which quick-change holder cone is designed to be clamped in an at least partially complementary holder receptacle of a basic holder of the quick-change chisel holder system, and a tension means bearing arranged on the quick-change holder cone, which bearing is designed to engage a tension means with which the quick-change holder cone can be clamped on the basic holder in the direction of a cone axis of the quick-change holder cone, in that the chisel shank receptacle and the tension means bearing are designed or positioned relative to one another in such a way that the longitudinal center axis of the chisel shank receptacle and the cone axis of the quick-change holder cone lie in a common plane and are angled relative to one another in this common plane. In other words, the longitudinal center axis and the cone axis are neither coaxial nor parallel to each other, but are at an angle to each other and both run or extend along their length in a common virtual plane. Thus, at least in their extension, the two axes intersect at an intersection point lying in this plane. As already mentioned, the longitudinal center axis is both the longitudinal center axis of the chisel shank receptacle and of the milling chisel once the latter is arranged in the chisel shank receptacle. The angulation of the longitudinal center axis relative to the cone axis therefore influences the relative position or the position of the milling chisel relative to the milling roller and thus also relative to the ground to be milled. The angle between the longitudinal center axis and the cone axis is selected here in such a way that the milling tools are subjected to an even load, especially in the case of thin-layer milling, which results in even wear of the milling chisel and also of the quick-change holder. The angulation here is such that the longitudinal center axis is tilted outwards in relation to the cone axis in the radial direction of the milling roller or in the radial direction of the rotation axis of the milling roller. In other words, the longitudinal center axis is angled relative to the cone axis in such a way that the chisel tip of a milling chisel arranged in the chisel shank receptacle projects more steeply from the milling roller than would be the case without the corresponding angulation. The milling chisel mounted in the chisel shank receptacle is therefore tilted away from the milling roller by the angulation. In this way, the contact angle between the chisel tip and the ground to be milled is optimized for milling depths in the thin-layer milling range, i.e. in particular for milling depths up to a maximum of 4 cm.

This results in a significantly improved and more uniform wear behavior compared to conventional quick-change holders, which leads to an increased service life of the milling chisel, the quick-change holder and the basic holder. At the same time, a fixed position of the milling chisel is specified by the quick-change holder due to the nature of the chisel shank receptacle, so that every milling chisel that is mounted on a milling roller or on a basic holder with such a quick-change holder automatically has the same angular position. This eliminates assembly errors. Lastly, the invention makes it possible to adapt a quick-change chisel holder system with a quick-change holder cone to thin-layer milling or for use on thin-layer milling machines. In particular, the fastening of the quick-change holder to the basic holder via the quick-change holder cone is left unchanged, so that this proven concept, which leads to long service life, can be retained even in the case of predominant or exclusive operation in thin-layer milling. In addition, the chisel shank is subjected to less bending stress due to the reduced setting angle for thin layer milling, which prevents shank fractures of the round-shank chisel and the formation of slots in the quick-change holder as well as oblique wear on the quick-change holder.

In principle, the angle by which the longitudinal center axis and the cone axis are angled relative to each other can be adjusted according to the needs of the specific application. For example, a quick-change holder can be created that is optimally designed for work of 4 cm milling depth or, for example, 2 cm milling depth. Preferred embodiments have shown that the longitudinal center axis and the cone axis are angled to each other, for example, by at least 3°, preferably by at least 5°, particularly preferably at least 8° and ideally by at least 10°. Particularly preferred embodiments provide that the longitudinal center axis and the cone axis are angled to each other by 4° or by 8°. In addition or alternatively, it is advantageous if the longitudinal center axis and the cone axis are angled to each other, for example, by a maximum of 25°, preferably by a maximum of 20°, particularly preferably by a maximum of 15°. The corresponding angular positions or angular ranges are distinguished by significantly improved wear behavior during thin-layer milling.

As already described, the longitudinal center axis and the cone axis run in a common virtual plane and are angled to each other. This means that the longitudinal center axis and the cone axis meet at exactly one intersection point. A particularly preferred geometric design of the quick-change holder is achieved when the intersection point is arranged in or within the quick-change holder and, in particular, in the chisel shank receptacle of the quick-change holder. The intersection point between the longitudinal center axis and the cone axis is thus preferably located within the maximum spatial extension of the quick-change holder itself outwardly and very particularly preferably within the space forming the chisel shank receptacle. The fact that the intersection point should be within the spatial extent of the quick-change holder does not therefore mean that the intersection point must be located where a material forming the quick-change holder body is actually arranged. Rather, the intersection point can also be located in a cavity of this material, such as the chisel shank receptacle, as long as this cavity is located inside the quick-change holder and is at least partially surrounded by the material of the quick-change holder body. In other words, the chisel shank receptacle is arranged on the cone axis. In particular, the chisel shank receptacle is arranged in front of the quick-change holder cone in the direction of rotation of the quick-change holder or the milling tool. If the quick-change holder is designed in accordance with the above embodiments, it is ensured that forces acting on the milling chisel and the quick-change holder during operation of the milling roller are reliably transmitted via the quick-change holder cone to the basic holder.

The lateral surface of the quick-change holder cone corresponds to the lateral surface of the truncated cone forming the quick-change holder cone. The lateral surface of the quick-change holder cone ends with the spatial extension of the quick-change holder cone itself. In other words, reference is only made to a lateral surface of the quick-change holder cone where the quick-change holder cone itself is also located. Beyond that, however, the extrapolated continuation of the lateral surface of the quick-change holder cone can also be considered. The extrapolated continuation of the lateral surface describes a theoretical surface in which the lateral surface of the quick-change holder cone would continue if the height of the truncated cone forming the quick-change holder cone were to be increased while maintaining the cone angle. According to a preferred embodiment of the invention, it is now provided that the longitudinal center axis passes through the lateral surface of the quick-change holder cone without overlapping. The quick-change holder is thus designed in such a way that the longitudinal center axis of the chisel shank receptacle passes through the lateral surface of the quick-change holder cone without intersecting it. There is therefore no intersection point between the longitudinal center axis and the lateral surface of the quick-change holder cone. The lateral surface forms a ring perpendicular to the longitudinal center axis, so to speak, through the center of which ring the longitudinal center axis runs. Additionally or alternatively, it can be provided that the longitudinal center axis intersects the extrapolated continuation of the lateral surface of the quick-change holder cone outside the lateral surface at an intersection point. Thus, an intersection point may very well exist between the longitudinal center axis and the extrapolated continuation of the lateral surface of the quick-change holder cone. To be more precise, there may even be two such intersection points, wherein only the intersection point closer to the quick-change holder will be considered here. In particular, the intersection point is located on the side of the quick-change holder on which the tension means bearing is arranged, but outside of the spatial extension thereof. This also results in a particularly advantageous transmission of force via the quick-change holder cone to the basic holder, especially during thin-layer milling.

As already described, the chisel shank receptacle is located in the quick-change holder body. Since the chisel shank to be received has a round shank, the chisel shank receptacle is basically a cylindrical recess in the quick-change holder body, symmetrical about the longitudinal center axis. Preferably, the quick-change holder body has a support shoulder which at least partially and in particular completely runs around an entrance of the chisel shank receptacle and ends in a support plane. The support shoulder thus forms at least partially an edge around the chisel shank receptacle. This edge, which forms the support shoulder, has a support surface which lies in the support plane. Typically, the support shoulder can be used as a counter bearing for a wear plate, which can be arranged between the support shoulder and the chisel head. The use of such wear plates with round-shank chisels is already known. In order to now further ensure a uniform loading and a uniform wear of the milling chisel as well as of the wear plate and the support shoulder, it is preferably provided that the support plane is arranged perpendicular to the longitudinal center axis and/or that the support plane is cut at an angle other than 90° from the cone axis. The fact that the support plane is arranged perpendicular to the longitudinal center axis ensures that the wear plate and the chisel head of the milling chisel obtain a perfect fit on the support shoulder even when the longitudinal center axis is angled in accordance with the invention. The perpendicular arrangement of the support plane to the longitudinal center axis and the angulation thereof to the cone axis also means that the support plane is not perpendicular to the cone axis. Specifically, the support plane is angled at the same angle plus 90° to the cone axis as the longitudinal center axis.

A particularly reliable introduction of forces from the quick-change holder into the basic holder is preferably achieved in the generic quick-change chisel holder system by the fact that the quick-change chisel holder system or the quick-change holder body comprises a basic grip which has a gripping arm designed to engage in a groove on the basic holder. In other words, the quick-change holder body forms a gripping arm that overlaps a part of the basic holder and, for example, projects into a groove formed on the basic holder. The basic grip or gripping arm thus prevents rotation of the quick-change holder in the basic holder. In addition, the basic grip is ideally arranged in such a way that it introduces forces occurring during operation of the milling roller, which act on the milling chisel and thus also on the quick-change holder due to contact with the ground, into the basic holder. Such a basic grip with a gripping arm is also mentioned in the aforementioned EP 2 425 951 A1, from which further details regarding the design of the basic grip can be taken. In a preferred embodiment of the present invention, it is now provided that the longitudinal center axis is angled away from the basic grip and in particular away from the gripping arm with respect to the cone axis. As a result of the angulation, the longitudinal center axis is thus inclined away from the gripping arm or from the basic grip. This refers in particular to the part of the longitudinal center axis running through the chisel tip. In other words, it refers to that part of the longitudinal center axis that is distant from the quick-change holder cone or the tension means bearing. In particular, the half of the longitudinal center axis that is inclined away from the basic grip lies behind the intersection point of the cone axis and the longitudinal center axis coming from the quick-change holder cone or the tension means bearing. In this way, even with the angled longitudinal center axis of the invention, the forces are optimally transmitted from the gripping arm to the basic holder.

The above-mentioned problem is likewise solved by a quick-change chisel holder system for fastening a milling chisel to a milling roller of a road milling machine, in particular with a milling chisel, comprising a basic holder and a quick-change holder according to the preceding embodiments. It is also solved by a milling roller for a road milling machine and by a road milling machine comprising such a milling roller, wherein the milling roller is designed to rotate about a roller rotation axis and comprises a quick-change chisel holder system according to the preceding embodiments fastened to the milling roller and a milling chisel with a chisel tip fastened to said quick-change chisel holder system. The above-mentioned features, effects and advantages of the quick-change holder according to the invention also apply in a figurative sense to both the quick-change chisel holder system according to the invention and the milling roller according to the invention, and vice versa. Reference is made to the other explanations in each case merely to avoid repetition.

According to a preferred embodiment of the milling roller, it is now provided that an angle between the longitudinal center axis of the chisel shank receptacle and a straight line running perpendicularly from the roller rotation axis and passing through the chisel tip is a maximum of 37°, preferably a maximum of 35°, particularly preferably a maximum of 32°and ideally a maximum of 30°. Particularly preferred angles are 36° or 32°. The straight line described thus runs radially from the roller rotation axis and intersects the chisel tip of the milling chisel. The specified angle can therefore be determined objectively on the milling roller itself, since, for example, the contact angle between the milling chisel and the ground to be milled depends on the milling depth. Such a dependency does not exist with the specified angle. Furthermore, it has been shown that the wear behavior of milling rollers with the specified angles is significantly improved, especially when carrying out predominantly thin-layer milling work.

Furthermore, it is preferably provided that an angle between the longitudinal center axis and an outer lateral surface of the milling roller is greater than an angle between the cone axis and the outer lateral surface of the milling roller. The outer lateral surface of the milling roller is the surface on the outside of the roller tube to which the basic holders are fastened, for example welded on. The angle at which this surface is intersected by the longitudinal center axis is thus preferably greater than the angle at which this surface is intersected by the cone axis. Preferably, the difference between the angles corresponds exactly to the angle between the longitudinal center axis and the cone axis.

### BRIEF DESCRIPTION OF THE DRAWINGS

The invention is explained in more detail below with reference to the exemplary embodiments shown in the figures, which show schematically:

FIG. 1 is a side view of a road milling machine;

FIG. 2 is a perspective side view of a milling roller;

FIG. 3 is a side view of a quick-change chisel holder system with a milling chisel;

FIG. 4 is a sectional view through the quick-change chisel holder system according to FIG. 3;

FIG. 5 is a perspective side view of a quick-change holder;

FIG. 6 is a sectional view through a prior art quick-change holder with a milling chisel;

FIG. 7 is a sectional view through a prior art quick-change holder;

FIG. 8 is a perspective side view of a prior art change holder;

FIG. 9 is a sectional view of a first embodiment of a quick-change holder with a milling chisel;

FIG. 10 is a sectional view of a first embodiment of a quick-change holder;

FIG. 11 is a perspective side view of a first embodiment of a quick-change holder;

FIG. 12 is a sectional view of a second embodiment of a quick-change holder with a milling chisel;

FIG. 13 is a sectional view of a second embodiment of a quick-change holder;

FIG. 14 is a perspective side view of a second embodiment of a quick-change holder;

FIG. 15 is a prior art milling chisel at the moment of contact with the ground; and

FIG. 16 is a milling chisel at the moment of contact with the ground.

### DETAILED DESCRIPTION

Components that are identical or have the same effect are designated with the same reference signs in the figures. Repeated components are not necessarily designated separately in each figure.

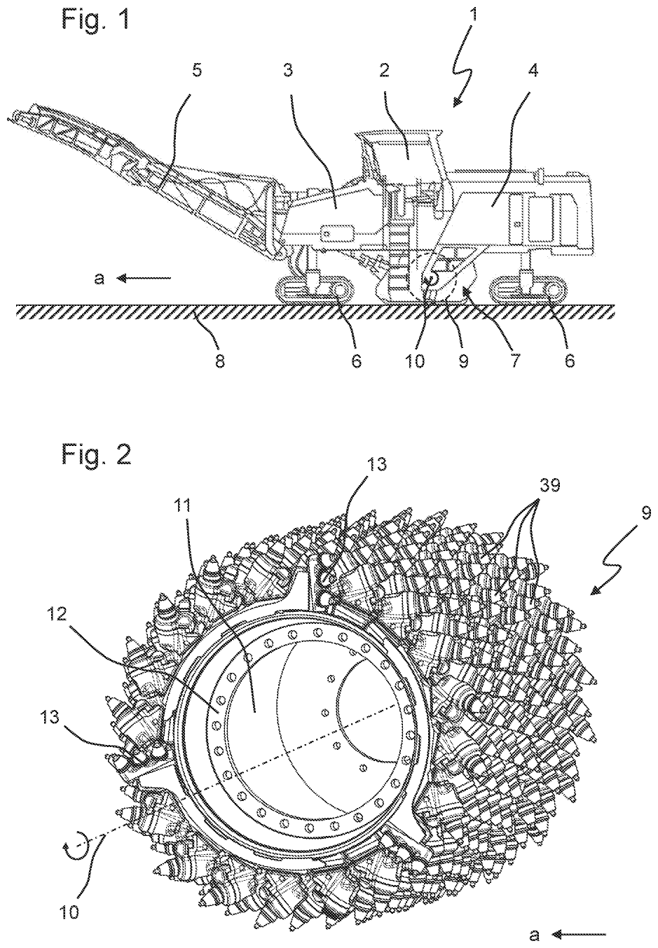

FIG. 1 shows a road milling machine 1, here in particular a cold miller of the center-rotor type. However, the invention is also applicable to road milling machines of the rear-rotor type. The road milling machine 1 comprises a machine frame 3 with a driver's cab 2. The machine frame 3 is supported by movement means 6, which in the exemplary embodiment shown are crawler tracks, but could also be wheels. The road milling machine 1 further comprises a milling roller 9 rotatably mounted in a milling roller box 7 about a roller rotation axis 10 running horizontally and transversely to a working direction a. The road milling machine 1 is itself mounted in a milling roller box 7. The road milling machine 1 is designed to be self-propelled and has a drive motor 4 which provides the necessary drive energy to operate the road milling machine 1. The drive engine 4 is typically an internal combustion engine, for example a diesel internal combustion engine. Alternatively, it can also be an electric motor. During operation, the road milling machine 1 moves in the working direction a over the ground 8 and mills it off. The loosened ground material is transported away from the milling roller box 7 and transferred to a conveyor device 5. The conveyor device 5 in turn transfers the milled material to a transport vehicle (not shown), for example a truck, which then transports it away. Some or all of the movement means 6 can be height-adjustable relative to the machine frame 6 by means of lifting devices, usually so-called lifting columns, in order to be able to vary the milling depth, for example.

FIG. 2 shows a perspective side view of the milling roller 9. This has a preferably substantially hollow-cylindrical roller tube 11, which can be connected to a drivetrain via a drive connection 12. A plurality of milling tools 39, which will be described in more detail below, are preferably arranged on the outer lateral surface of the milling roller 9. Furthermore, side cutters 13 can be arranged on the shown end face of the milling roller 9, which cut a lateral clearance for the milling roller 9 in the ground 8 during operation.

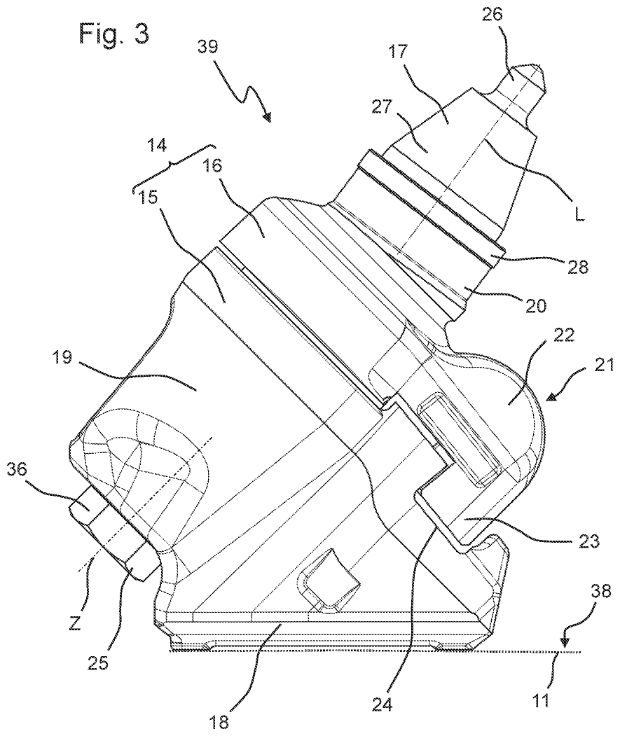

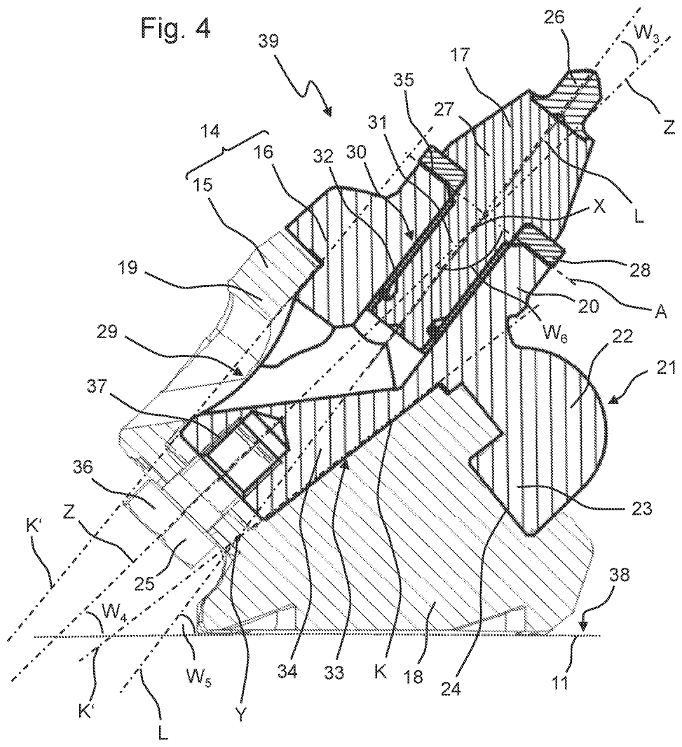

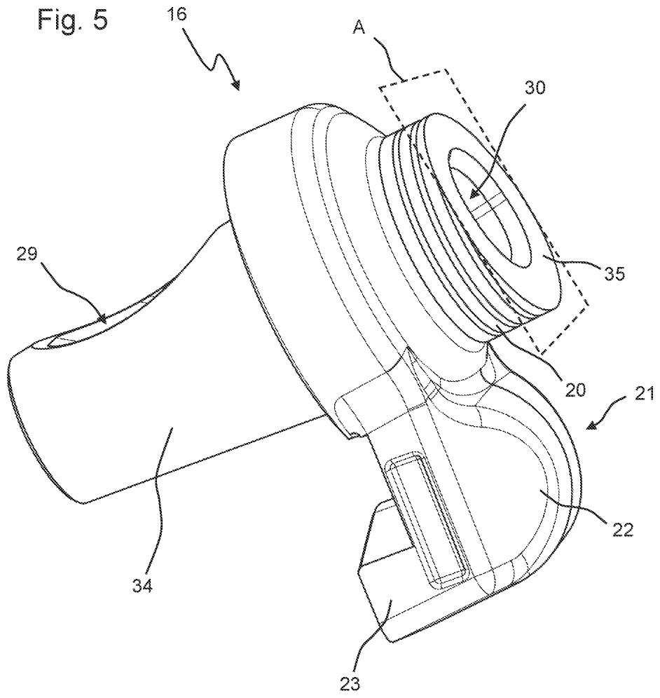

An embodiment of a milling tool 39 is shown in FIG. 3. The milling tool 39 preferably comprises a quick-change chisel holder system 14 with a basic holder 15 and a quick-change holder 16. A milling chisel 17 is in turn preferably mounted on or in the quick-change holder 16. A cross-section through the milling tool 39 according to FIG. 3 is shown in FIG. 4. FIG. 5 in turn shows a perspective view of the quick-change holder 16 alone. The basic holder 15 preferably has a fastening foot 18, by means of which the basic holder 15 can be fastenable to the outer lateral surface 38 of the roller tube 11. In addition, the basic holder 15 preferably comprises a holder receiving part 19, in which a holder receptacle 33 can be arranged. The holder receptacle 33 is preferably complementary to the quick-change holder cone 34 formed by the quick-change holder body 20 of the quick-change holder 16. In the assembled state, the quick-change holder 16 is preferably mounted with the quick-change holder cone 34 in the holder receptacle 33, more specifically in such a way that the lateral surface K of the quick-change holder cone 34 lies flat, and preferably at least partially running around the cone axis Z, against the inner surface of the holder receptacle 33. A tension device 25 with a tension means 36, for example a screw, is preferably provided for fastening the quick-change holder 16 to the basic holder 15. The tension means 36 preferably penetrates the basic holder and projects into the holder receptacle 33. The quick-change holder cone 34 is in turn preferably provided with a tension means bearing 37, for example a bore with an internal thread, which can be designed to receive the tension means 36. Overall, the tension device 25 and in particular the tension means bearing 37 of the quick-change holder 16 is preferably designed in such a way that the tensile force of the tension means 36 on the quick-change holder 16 acts along the cone axis Z. In particular, the tensile force of the tension means 36 presses the lateral surface K of the quick-change holder cone 34 against the inner surface of the holder receptacle 33 of the basic holder 15. In this way, forces acting on the milling chisel 17 and the quick-change holder 16 during operation of the milling roller 9 can be efficiently transmitted to the basic holder 15 and thus likewise to the roller tube 11 of the milling roller 9. This type of force transmission between the quick-change holder 16 and the basic holder 15 via the quick-change holder cone 34 is furthermore a defining feature of a quick-change chisel holder system 14 with quick-change holder cone 34 and distinguishes it from other quick-change chisel holder systems.

In addition, a chisel shank receptacle 30 is preferably arranged in the quick-change holder body 20. The chisel shank receptacle 30 is in particular a cylindrical cavity which is complementary to a chisel shank 31 of the milling chisel 17. It preferably has a longitudinal center axis L which corresponds in particular to the rotation axis of the cylindrical cavity, and in the assembled state of the milling chisel 17 likewise to the rotation axis of the milling chisel 17. The rotation axis of the milling chisel 17 preferably corresponds here both to the structural rotation axis of the rotationally symmetrical milling chisel 17, which is in particular a round-shank chisel, and to the rotation axis about which the milling chisel 17 can rotate during operation of the milling roller 9. The chisel shank receptacle 30 is preferably arranged along the cone axis Z and lies in particular on the cone axis Z. The chisel shank receptacle is preferably designed to receive the chisel shank 31 and a clamping sleeve 32, wherein the clamping sleeve 32 at least partially surrounds the chisel shank 31 and, by way of an interlocking fit, prevents an axial displacement and thus a pulling out or falling out of the milling tool 17 from the chisel shank receptacle 30. The chisel shank receptacle 30 is preferably at least partially surrounded by a support shoulder 35 on the side of the quick-change holder body 20 opposite the tension means bearing 37 or the quick-change holder cone 34. The support shoulder 35 preferably runs around the chisel shank receptacle 30 at least partially and in particular completely. In addition, the support shoulder 35 preferably forms a support surface lying in the support plane A. The support plane A is preferably arranged perpendicularly to the longitudinal center axis L. The support shoulder 35 preferably serves as an abutment for a wear plate 28 resting against it, which likewise preferably completely runs around the chisel shank receptacle 30 and against which the chisel head 27 of the milling chisel 17 bears by means of a rear abutment. In addition to the chisel shank 31 and the chisel head 27, the milling chisel 17 also comprises, in particular, a chisel tip 26, which is typically formed at least partially from hard metal. During operation of the road milling machine 1 or the milling rollers 9, the milling chisel 17 is preferably designed to be rotatable about the longitudinal center axis L, which leads to uniform wear of the milling chisel 17.

In addition, the quick-change holder body 20 preferably forms a basic grip 21. The basic grip 21 preferably comprises a web region 22 and a gripping arm 23. The web region 22 preferably comprises an upward curvature which is directed away from the gripping arm and from the basic holder or from the quick-change holder cone 34 and which serves to comminute lumps of milling material thrown around during milling operation and to absorb the wear occurring during this process instead of the basic holder 15. The gripping arm 23 in turn is preferably complementary to a groove 24 on the basic holder 15 and in particular engages in this groove 24. Forces directed away from the milling roller 9 can preferably be introduced by way of an interlocking fit from the quick-change holder 16 into the basic holder 15 via the gripping arm 23. This gripping arm 23 and the corresponding force transmission from the quick-change holder 16 to the basic holder 15 is also a typical feature of quick-change chisel holder systems 14 with quick-change holder cone 34.

The quick-change holder body 20 additionally preferably has an expulsion opening 29. The expulsion opening 29 is preferably arranged on the side of the quick-change holder body 20 opposite the basic grip 21 and, in particular, represents a cavity which leads from the outside of the quick-change holder body 20 to the chisel shank receptacle 30 and is connected thereto. The rear end of the chisel shank 31 is therefore preferably accessible from the outside through the expulsion opening 29. In order to ensure this accessibility in the fully assembled state of the quick-change chisel holder system 14, a corresponding expulsion opening 29 is preferably likewise provided in the basic holder 15 and extends from the outside of the basic holder 15 into the holder receptacle 33 and is connected thereto. In particular, the expulsion opening 29 in the basic holder 15 is designed in such a way that it is in communication with the expulsion opening 29 in the quick-change holder 16 when the quick-change holder 16 is mounted in the basic holder 15. Overall, the expulsion opening 29 therefore preferably provides open access to the rear end of the chisel shank 31 of the milling chisel 17, starting from the outside of the quick-change chisel holder system 14. A tool can therefore be inserted through the expulsion opening 29 and comes into contact with the chisel shank 31 so that this can be expelled, for example with targeted hammer blows.

The longitudinal center axis L of the chisel shank receptacle 30 is preferably angled relative to the cone axis Z by the angle W₃. Preferably, the longitudinal center axis L and the cone axis Z lie in a common plane so that they meet at an intersection point X. The intersection point X is preferably located within the spatial extent of the quick-change holder 16. Particularly preferably, the intersection point X is located in the cylindrical cavity of the chisel shank receptacle 30. In particular, the longitudinal center axis L is angled away from the basic grip 21 relative to the cone axis Z by the angle W₃. In particular, this refers to that portion of the longitudinal center axis L that is remote from the quick-change holder cone 34 and the tension means bearing 37, respectively. In other words, that half of the longitudinal center axis L which is angled away from the basic grip 21 is located behind the intersection point X of the cone axis Z and the longitudinal center axis L, coming from the quick-change holder cone 34 or the tension means bearing 37. By contrast, that half of the longitudinal center axis L which is directed towards the quick-change holder cone 34 or the tension means bearing 37 can be inclined towards the basic grip 21 due to the angulation between the longitudinal center axis L and the cone axis Z. The corresponding angulation preferably ensures that the chisel tip 26 of a milling chisel 17 mounted on the quick-change holder 16 is oriented away from the milling roller 9 or the outer lateral surface 38 of the roller tube 11. The longitudinal center axis L and also the milling chisel 17 are therefore preferably positioned more steeply in relation to the outer lateral surface 38 as a result of the angulation, which brings with it the advantages described for thin-layer milling.

As shown in particular in FIG. 4, the angle W₄ between the cone axis Z and the outer lateral surface 38 of the roller tube 11 is preferably smaller than the angle W₅ between the longitudinal center axis L and the outer lateral surface 38 of the roller tube 11. The difference between the angles W₄, W₅ corresponds in particular to the angulation between the longitudinal center axis L and the cone axis Z. In the shown exemplary embodiment of FIG. 4, the angle W₃ is for example 8°, the angle W₄ for example 44°, and the angle W₅ for example 52°. As already mentioned, the support plane A of the support shoulder 35 is preferably arranged perpendicularly to the longitudinal center axis L. It follows from this that the support plane A is preferably not oriented perpendicularly to the cone axis Z. The angle W₆ between the support plane A and the cone axis Z is therefore preferably an angle not equal to 90°. The angle W₆ is, for example, 90° plus the angle W₃ between the longitudinal center axis L and the cone axis Z, in the shown exemplary embodiment in FIG. 4 therefore 98°, for example.

As can also be seen in particular from FIG. 4, the longitudinal center axis L preferably does not intersect the lateral surface K of the quick-change holder cone 34. Although the longitudinal center axis L preferably passes through the lateral surface K of the truncated cone forming the quick-change holder cone 34, it preferably only penetrates its base surface and its top surface, but not the lateral surface K. However, if an extrapolated continuation K′ of the lateral surface K is considered, wherein the extrapolated continuation K′ lies outside the actual, real existing surface of the quick-change holder cone 34, it is preferred that the longitudinal center axis L intersects the extrapolated continuation K′ of the lateral surface K at an intersection point Y. The intersection point Y, in turn, preferably lies within the spatial extension of the basic holder 15. Additionally or alternatively, it can be provided that the intersection point Y is the point closest to the outer lateral surface 38 of the roller tube 11 of a section which is taken through the extrapolated continuation K′ of the lateral surface K and which is guided perpendicularly to the cone axis Z.

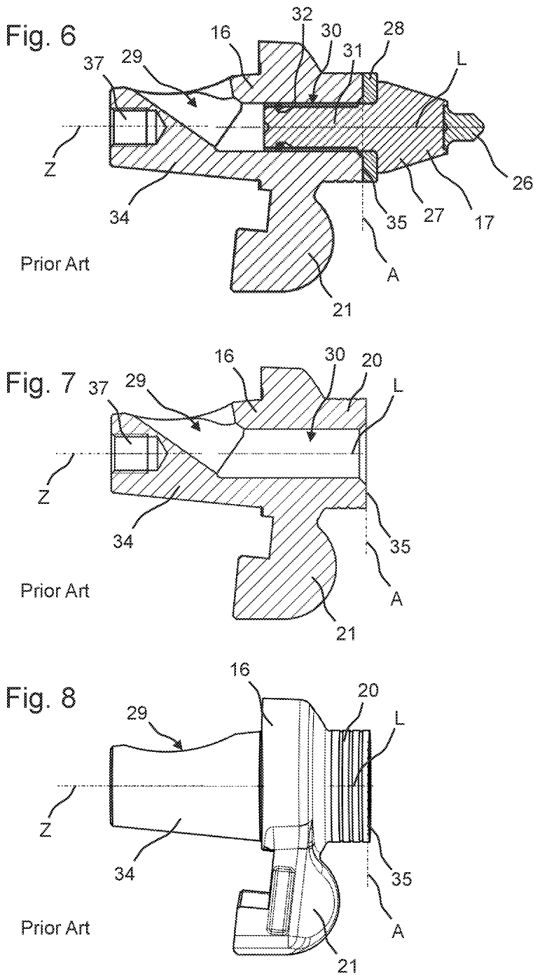

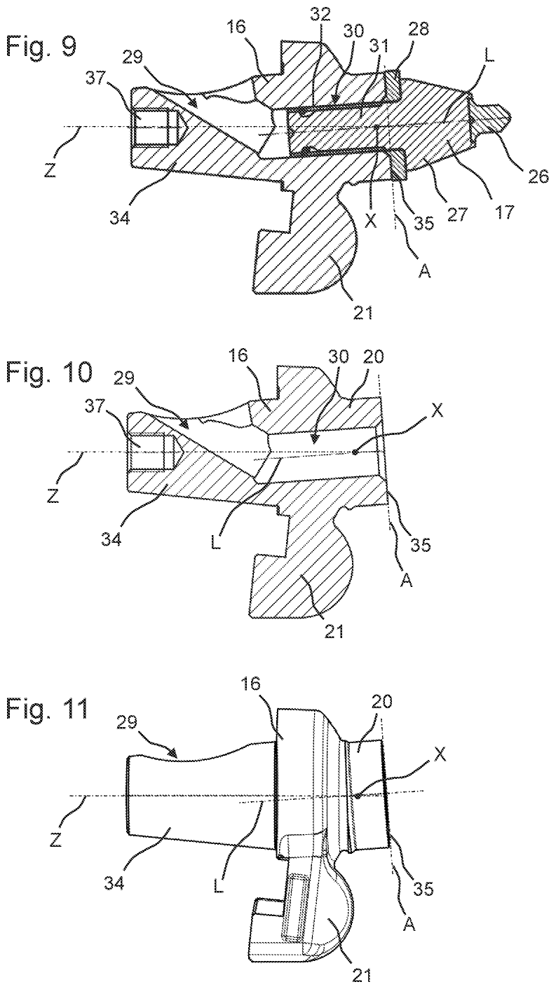

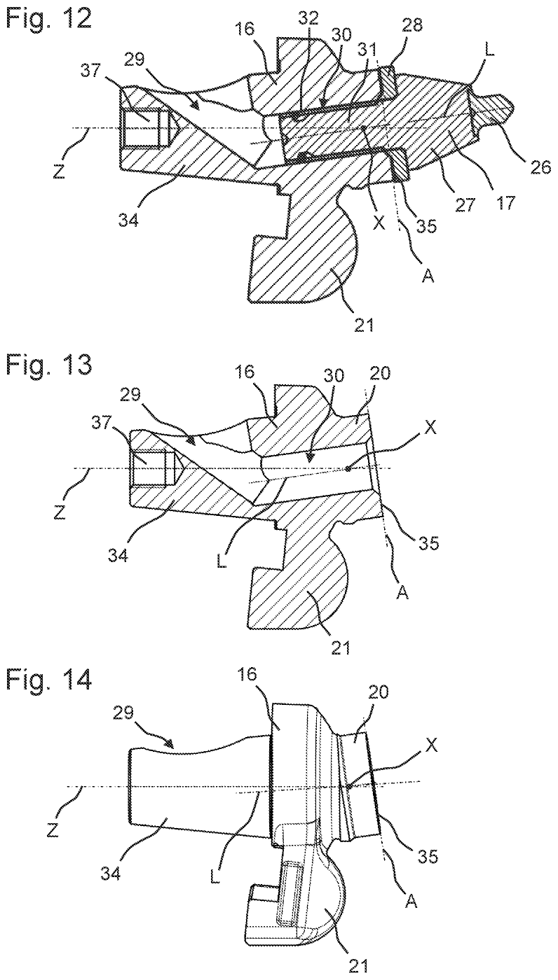

FIGS. 6-14 show a comparison of the prior art (FIGS. 6-8) with a first exemplary embodiment (FIGS. 9-11) and a second exemplary embodiment (FIGS. 12-14) of the invention, showing a cross-section through the quick-change holder 16 with a milling chisel 17 (FIGS. 6, 9 and 12), a cross-section through the quick-change holder 16 alone (FIGS. 7, 10 and 13), and a side view of the quick-change holder 16 (FIGS. 8, 11 and 14). FIGS. 6-8 show the prior art as also detailed in EP 2 425 951 A1. In the prior art, the longitudinal center axis L and the cone axis Z are parallel to each other and coaxial, i.e. the two axes are identical. In other words, the longitudinal center axis L and the cone axis Z have an infinite number of intersection points. By contrast, in the exemplary embodiments of the invention according to FIGS. 9-14, the longitudinal center axis L and the cone axis Z are not identical, but are angled relative to each other. However, they preferably lie in the same plane so that they have, in particular, exactly one intersection point X. In the exemplary embodiment according to FIGS. 9-11, the angle W₃ between the longitudinal center axis L and the cone axis Z is, for example, 4°, while in the exemplary embodiment according to FIGS. 12-14 it is, for example, 8°.

As can be seen in particular from a comparison of FIGS. 6-8 concerning the prior art with the exemplary embodiments of the invention according to FIGS. 9-14, it is preferred that only the orientation of the chisel shank receptacle 30 and the support shoulder 35, which are each tilted by the angle W₃, changes compared to the prior art. In particular, all shapes and surfaces of the quick-change holder 16 which come into contact with the basic holder 15 in the assembled state of the quick-change chisel holder system 14 are unchanged compared to the prior art, so that one and the same basic holder 15, as known from the prior art, can also be used in combination with a quick-change holder 16 according to the invention. For the use of the quick-change holder 16 according to the invention, it is therefore not necessary to manufacture a separate basic holder 15 or to mount it on the milling rollers 9. This leads to reduced manufacturing and usage costs of the system according to the invention. Furthermore, a quick-change holder 16 according to the invention can be retrofitted particularly easily to existing milling rollers 9 by simply attaching it to the basic holders 15 already present there in the usual manner Conversion of an existing milling roller 9 for upcoming thin-layer milling work is therefore also possible quickly and easily.

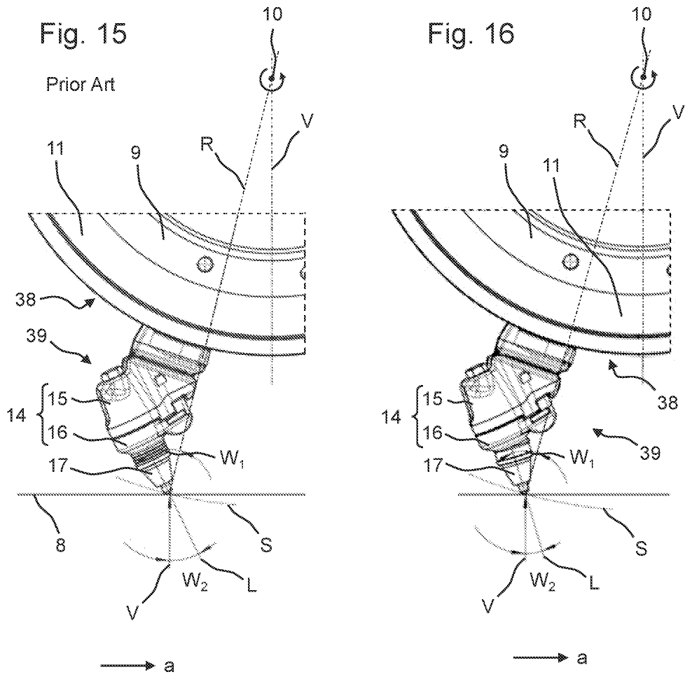

FIGS. 15 and 16 show a comparison between a milling tool 39 according to the prior art (FIG. 15) and a milling tool 39 according to the invention (FIG. 16) in working operation of the milling roller 9. In particular, FIGS. 15 and 16 show the moment during operation when the milling chisel 17 comes into contact with the ground 8 to be milled off. For this purpose, the milling roller 9 rotates about the roller rotation axis 10. The path curve along which the chisel tip 26 of the milling chisel 17 moves as a result of this rotation is referred to as the cutting circle S. The angle W₁ lies between the longitudinal center axis L and a straight line R which starts perpendicularly from the roller rotation axis 10 and runs through the chisel tip 26. The straight line R thus starts radially from the roller rotation axis 10 and intersects the chisel tip 26. In the prior art case shown in FIG. 15, the angle W₁ is greater than in the case of the milling tool 39 according to the invention, which is shown in FIG. 16. In the specific example shown, the angle W₁ is 40° in FIGS. 15 and 32° in FIG. 16. In the invention, it is preferred that the angle W₁ is 40° minus the angle W₃ between the longitudinal center axis L and the cone axis Z. This results in the angle W₂, which is between the longitudinal center axis L and a vertical V, being reduced compared to the prior art. In the example shown, the angle W₂ is 24° on the left and 16° on the right. In the invention, it is preferred that the angle W₂ is 24° minus the angle W₃ between the longitudinal center axis L and the cone axis Z. As can be seen from FIG. 15, this ensures that the milling chisel 17 is oriented more steeply to the ground 8 at the moment of contact with the ground than in the prior art. This results in a more even load on the milling chisel and the quick-change holder, particularly in thin-layer milling, so that they wear more evenly and have a longer service life overall.

What is claimed is:

1. A quick-change holder for a quick-change chisel holder system for fastening a milling tool, which is rotationally symmetrical, to a milling roller of a road milling machine, comprising:
a quick-change holder body;
a chisel shank receptacle running along a longitudinal center axis in the quick-change holder body for receiving a chisel shank of the milling chisel;
a quick-change holder cone, which is formed by the quick-change holder body, lies at least partially in extension of the chisel shank receptacle and is designed to be clamped in an at least partially complementary holder receptacle of a basic holder of the quick-change chisel holder system; and
a tension means bearing arranged on the quick-change holder cone and designed to engage a tension means with which the quick-change holder cone can be clamped on the basic holder in the direction of a cone axis of the quick-change holder cone, wherein
the chisel shank receptacle and the tension means bearing are formed in such a way that the longitudinal center axis and the cone axis lie in a common plane and are angled relative to one another in this common plane.

2. The quick-change holder according to claim 1, wherein the longitudinal center axis and the cone axis are angled relative to one another by at least 3°, preferably by at least 5°, particularly preferably by at least 8° and ideally by at least 10°.

3. The quick-change holder according to claim 1, wherein it is designed in such a way that the longitudinal center axis and the cone axis meet at an intersection point, and in that the intersection point is located in the quick-change holder, in particular in the chisel shank receptacle.

4. The quick-change holder according to claim 1, wherein the longitudinal center axis passes through a lateral surface of the quick-change holder cone without overlapping and/or intersects an extrapolated continuation of the lateral surface of the quick-change holder cone outside the lateral surface at an intersection point.

5. The quick-change holder according to claim 1, wherein the quick-change holder body has a support shoulder, which at least partially runs around an entrance of the chisel shank receptacle and ends in a support plane, and in that the support plane is arranged perpendicularly to the longitudinal center axis and/or is intersected at an angle other than 90° by the cone axis.

6. The quick-change holder according to claim 1, wherein the quick-change holder body comprises a basic grip, which has a gripping arm designed to engage in a groove on the basic holder, and in that the longitudinal center axis is angled away from the basic grip, and in particular away from the gripping arm, with respect to the cone axis.

7. A quick-change chisel holder system for fastening a milling chisel to a milling roller of a road milling machine, in particular with a milling chisel, comprising a basic holder and a quick-change holder according to claim 1.

8. A milling roller for a road milling machine, wherein the milling roller is designed to rotate about a roller rotation axis and comprises a quick-change chisel holder system according to claim 7 fastened to the milling roller and a milling chisel with a chisel tip fastened thereto.

9. The milling roller according to claim 8, wherein an angle between the longitudinal center axis of the chisel shank receptacle and a straight line which starts perpendicularly from the roller rotation axis and runs through the chisel tip is at most 37°, preferably at most 35°, particularly preferably at most 32° and ideally at most 30°.

10. The milling roller according to claim 8, wherein an angle between the longitudinal center axis and an outer lateral surface of the milling roller is greater than an angle between the cone axis and the outer lateral surface of the milling roller.

11. A road milling machine, wherein it comprises a milling roller according to claim 8.
